(19) United States
(12) Patent Application Publication
(10) Pub. No.: US 2012/0027043 A1
(43) Pub. Date: Feb. 2, 2012

(54) HIGH POWER MULTI-CHIP PUMP MODULES WITH PROTECTION FILTER FOR 1060NM, AND PUMP MODULES INCLUDING THE SAME

(76) Inventor: Bernhard Valk, Switzerland (CH)

(21) Appl. No.: 13/145,011

(22) PCT Filed: Jan. 19, 2010
(86) PCT No.: PCT/IB2010/000085

§ 371 Date: Sep. 15, 2011

Related U.S. Application Data
(60) Provisional application No. 61/145,625, filed on Jan. 19, 2009.

(51) Int. Cl. H01S 3/091

(52) U.S. Cl. 372/70

(57) ABSTRACT

A multi-chip pump unit comprising a light source and a filter for directing light from the light source towards an optical fiber, wherein the filter exhibits one of either (i) relatively low transmissivity and high reflectivity at a wavelength of the light source, and relatively high transmissivity and low reflectivity at a wavelength greater than the wavelength of the light source; or (ii) relatively high transmissivity and low reflectivity at a wavelength of the light source, and relatively low transmissivity and high reflectivity at a wavelength greater than the wavelength of the light source.

This is application claims priority to U.S. Provisional Application No. 61/145,625 filed on Jan. 19, 2009, the entire contents of which are expressly incorporated by reference herein.

### TECHNICAL FIELD OF THE INVENTION

The present invention relates to high power pump modules for pumping fiber lasers, and more specifically to the filters used therein.

### DESCRIPTION OF THE RELATED ART

High power pump modules are used for pumping fiber lasers. The pump wavelength is 910-980 nm while the fiber laser/amplifier wavelength is above 1000 nm. Without isolation some light of the fiber laser traveling in a backward direction may enter the pump module causing damage of the semiconductor chip.

In order to prevent this damage some companies apply a coating onto the fiber end before the chip (lensed fiber) or if applicable onto both, the focusing optics between the chip and fiber end as well as the fiber end itself. This coating transmits the pump light at 900-1000 nm and reflects the backwards traveling light above 1000 nm. A disadvantage of this protection scheme is the distortions caused in the fiber laser or amplifier by this back reflected light from the pump module.

Reference is made to U.S. patent application Ser. No. 12/058,459, filed on Mar. 28, 2008, which describes an existing multi-chip pump module structure.

### SUMMARY

The present invention provides protection of the semiconductor chips in the pump module from light pulses traveling towards the semiconductor chips. In the present invention, the filters in the pump module are coated with a dielectric film and/or include multiple layers that reflect the pump light into the fiber and transmit the light entering the pigtail fiber from the system side. This light hits the housing wall or an absorber and is annihilated.

The light above 1000 nm (e.g., 1060 nm) is transmitted through the filters and hits the wall where part of it is absorbed and part reflect and defocused. The back reflected energy is transformed to heat which is removed via a heat sink on which the module is mounted

The pump modules are more reliable and robust in operation and simultaneously the amplifier is protected from above 1000 nm (e.g., 1060 nm) reflected back into the amplifier by the pump module. This is especially important for pulsed operation of the amplifier or fiber laser.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic illustration of a multi-chip pump module incorporating filters in accordance with an embodiment of the present invention;

FIGS. 2 and 3 represent the transmissivity and reflectivity, respectively, of each filter in relation to wavelength in accordance with an embodiment of the present invention; and

FIG. 4 is a schematic illustration of a multi-chip pump module incorporating filters in accordance with another embodiment of the present invention.

### DETAILED DESCRIPTION OF EMBODIMENTS

A pump module in accordance with the present invention uses one or more filters that reflect the pump light for coupling into the fiber pigtail while transmitting light of >1000 nm wavelength entering the module from the fiber. This way the light entering the module can not reach the chip so as to cause any damage.

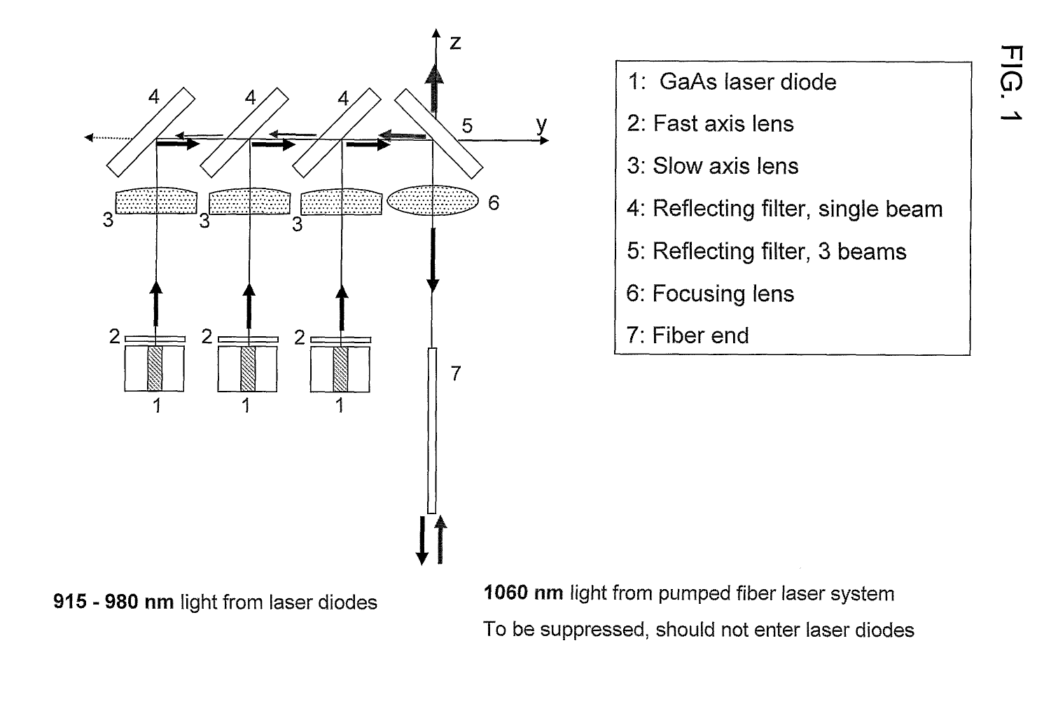

Referring to FIG. 1, a multi-chip pump module in accordance with an embodiment of the present invention is shown. The module includes multiple laser diodes 1, for example GaAs laser diodes, for providing suitable pumping power. In the exemplary embodiment the multi-chip pump module includes three laser diodes 1, but the module may incorporate any different number of laser diodes (or other type light sources) without departing from the scope of the invention.

Each laser diode 1 emits light having a wavelength in the band 750 nm to 1000 nm, more preferably in the band 915 nm to 980 nm, for example. Light emitted from each laser diode 1 passes through a corresponding fast axis lens 2 and slow axis lens 3 prior to being incident on a corresponding reflecting filter 4. As is described in more detail below, each reflecting filter 4 includes multiple layers and/or a film or coating which enables the filter 4 to substantially reflect incident light at 750 nm to 1000 nm, more preferably at 910 nm to 980 nm, and to substantially transmit light greater than 1000 nm.

Each filter 4 is positioned along the optical axis of the corresponding laser diode 1 (e.g., at 45°) such that the light from each of the laser diodes 1 is ultimately combined along optical path Y as shown in FIG. 1. The combined light beams are incident upon the reflecting filter 5, also oriented at 45° with respect to the optical path Y, for example. The reflecting filter 5 redirects the combined light beams along optical path Z through a focusing lens 6 and into the optical fiber 7 to be pumped. Similar in construction to each filter 4, the reflecting filter 5 substantially reflects incident light at 750 nm to 1000 nm, more preferably at 910 nm to 980 nm, and substantially transmits light at wavelengths greater than 1000 nm.

As mentioned above, it is undesirable for light at wavelengths greater than 1000 nm to enter the pump module from the fiber 7. In particular, it is important to avoid such light reaching the laser diodes and damaging the semiconductor chips making up such diodes.

In the present invention, the reflecting filters 4 and reflecting filter 5 include multiple layers and/or an optical film or coating which renders the filters substantially reflective with respect to light having a wavelength between 750 nm to 1000 nm, more preferably between 910 nm to 980 nm, and substantially transmissive with respect to light at wavelengths greater than 1000 nm. In the event light at wavelengths greater than 1000 nm enters the pump module from the fiber 7 along optical path Z, the light will be incident upon the reflecting filter 5. Since the reflecting filter 5 is substantially transmissive with respect to light at wavelengths greater than 1000 nm, the light will substantially pass through the reflecting filter 5 where it may be absorbed by an absorber (not shown) along the optical path Z.

Since the reflecting filter 5 may not be 100% transmissive with respect to light at wavelengths greater than 1000 nm, a small portion of the light may be reflected by the reflecting filter 5 back along the optical axis Y. However, such light will then be incident on the reflecting filters 4 adjacent the reflecting filter 5. Again since the reflecting filters 4 are substantially transmissive to light at wavelengths greater than 1000 nm, the vast majority of any remaining light at greater than 1000 nm will be transmitted through each reflecting filter 4 along the optical path Y where any further remaining light may be absorbed ultimately by an absorber (not shown). To the extent the reflecting filters 4 may not be 100% transmissive relative the light at greater than 1000 nm, any residual light ultimately reflected back towards the laser diodes 1 will be nominal.

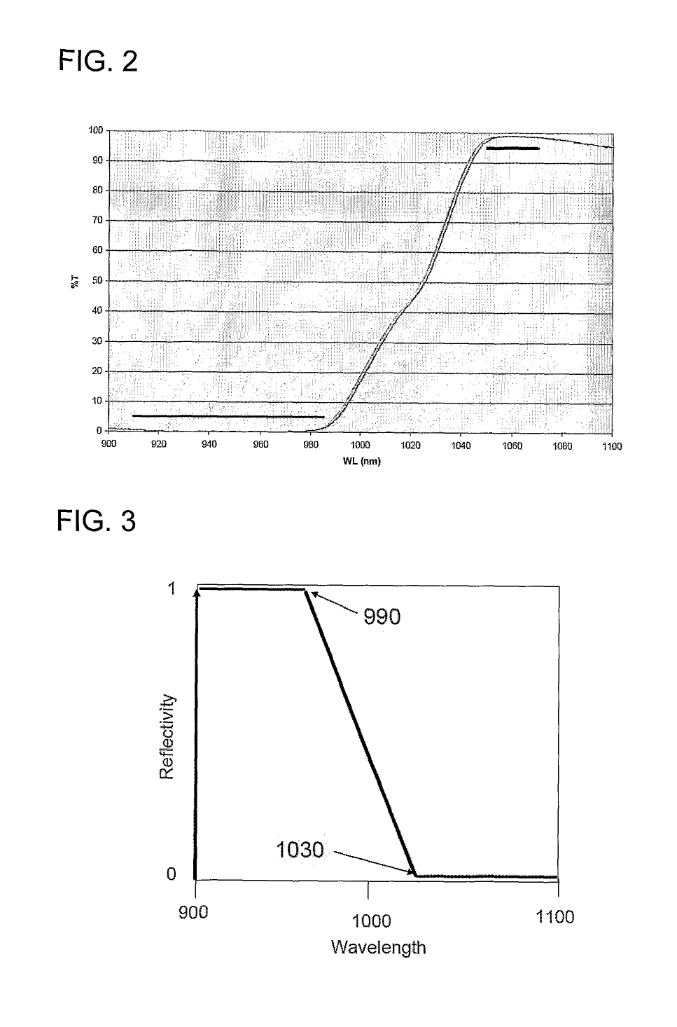

FIGS. 2 and 3 illustrate how the transmissivity and reflectivity of the reflecting filters 4 and 5, respectively, varies with respect to wavelength in accordance with the exemplary embodiment.

Regarding the reflecting filters 4 and 5, the filters are configured to exhibit high transmissivity at wavelengths greater than 1000 nm and high reflectivity with respect to wavelengths between 750 nm to 1000 nm, more preferably between 910 nm to 980 nm as previously noted.

According to an exemplary embodiment, the filters 4 and 5 as shown in FIG. 1 are designed to minimize edge splitting and pass band ripple while maximizing stop band reflectivity and pass band transmittance. Each filter is all-dielectric configured with alternating layers of high (tantalum pentoxide) and low (silicon dioxide) index materials. The thickness of each layer is a quarterwave at the design wavelength with the exception of those layers adjacent to the incident medium. The layers adjacent to the incident medium are adjusted to maximize pass band transmittance and minimize ripple. As referred to herein, “index” refers to the index of refraction as understood by those having ordinary skill in the art.

In the exemplary embodiment, the construction of each filter 4 and 5 is a cascaded Fabry-Perot type with high index spacers (cavities—multiple halfwave layers). The reason for the selection of high index spacers is to minimize spectral blue shift when the filter is used in non-collimated light (i.e.; oblique incidence, half cone angle, etc.). Another reason for the selection of high index spacers is that the metric thickness of the layer is less than that of low index spacers. The most important reason for using high index spacers sandwiched between low index layers (or vice versa) is to facilitate edge tuning. By manipulating the spacer order the band edges of the two planes are shifted (one plane moving faster than the other). Edge alignment comes at the expense of stop band reduction therefore a compromise must be made to achieve both sufficient stop band and pass band width.

Cascading the Fabry-Perot increases stop band reflectivity and edge steepness. A schematic representation of the filter construction is:
Substrate
Quarterwave matching layers
(HL) mHH (LH) L
[(HL) m′HH (LH) L]P
(HL) mHH (LH) L
Non-Quarterwave matching layers
Incident Medium
Where P=number of repetitions of the Fabry-Perot
   m=spacer order=1, 2, 3, . . . .
   m′=the spacers need not be of the same order
With H and L designating high and low index quarterwave layers respectively.

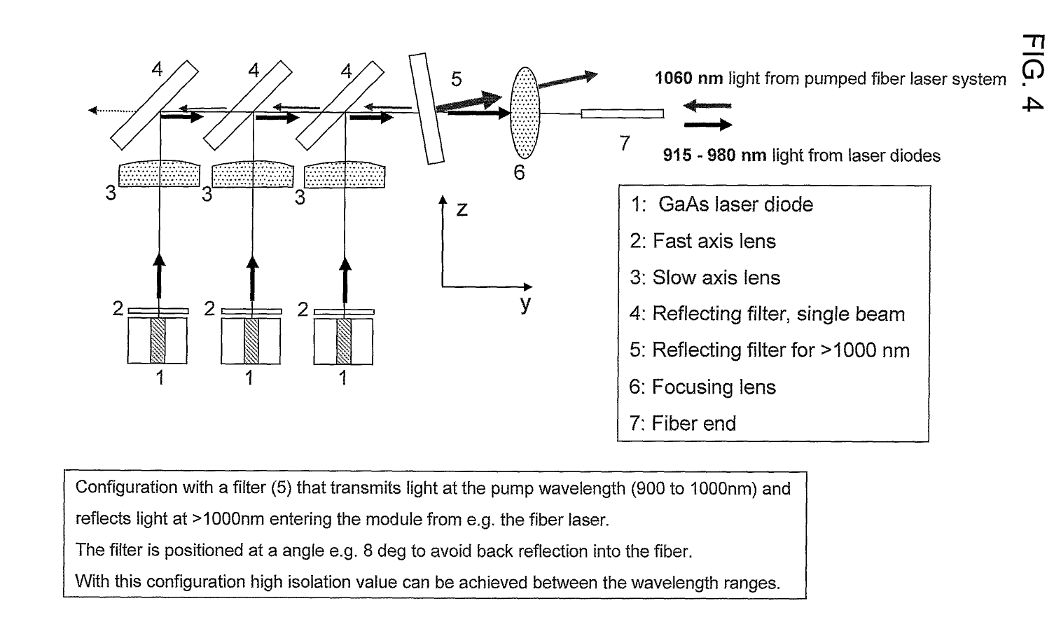

Referring now to FIG. 4, a pump module is shown in accordance with another embodiment of the present invention. In this particular embodiment, the arrangement and construction of the laser diodes 1, fast axis lenses 2, slow axis lenses 3, and corresponding reflecting filters 4 are the same as that described above in relation to the embodiment of FIG. 1. Therefore, for sake of brevity only the primary distinctions between the embodiments of FIGS. 1 and 4 will be discussed herein.

The reflecting filter 5 in this particular embodiment differs from that in the embodiment of FIG. 1 in that the reflecting filter 5 is designed to substantially transmit light at 750 nm to 1000 nm, more preferably at 910 nm to 980 nm, and to substantially reflect light greater than 1000 nm. As is shown in FIG. 4, the filter 5 is placed on the optical path Y along which the light beams from the laser diodes 1 are combined. The combined light beams are incident upon the reflecting filter 5, which in the exemplary embodiment is oriented preferably at an angle of approximately 8° from normal relative to the optical path Y.

Since the reflecting filter 5 substantially transmits the light from the laser diodes at 750 nm to 1000 nm, more preferably at 910 nm to 980 nm, the light beams pass through the filter 5 and are focused by lens 6 into the fiber end 7. Note that in this embodiment the lens 6 and fiber end 7 also are positioned along the optical path Y.

In the event light at wavelengths greater than 1000 nm enters the pump module from the fiber 7 along optical path Y, the light will be incident upon the reflecting filter 5. Since the reflecting filter 5 is substantially reflective with respect to light at wavelengths greater than 1000 nm, the light will substantially be reflected by the reflecting filter 5. Consequently, the light at wavelengths greater than 1000 nm is directed away from the filters 4 and laser diodes 1. In addition, since the filter 5 is positioned at a slight angle relative to normal (e.g., 8°) it is possible to avoid reflection back into the fiber end 7. Instead, the light may be directed at the slight angle above the optical path Y towards an optical absorber or the like (not shown).

Thus, in the embodiment of FIG. 4 the filter 5 is used at near normal incidence. This clean up filter is designed to transmit (pass band) with high efficiency the pump wavelengths and to reflect (stop band) with high efficiency the lasing wavelengths. The filter 5 provides greater than 35 dB isolation between wavelengths separated by 4%. The filter according to an exemplary construction is all-dielectric configured with alternating layers of high (H: tantalum pentoxide) and low (L: silicon dioxide) index materials. The thickness of each layer is a quarterwave at the design wavelength with the exception of those layers adjacent to the incident medium. A schematic representation of the filter construction is:
Substrate
Quarterwave matching layers
(0.5 L H 0.5 L)P
Non-Quarterwave matching layers
Incident Medium
where P=number of repetitions of the fundamental period
H and L designating high and low index quarterwave layers respectively.

In general as the number of repetitions of the fundamental period is increased the stop band reflectance increases. One consequence of increasing P is increased secondary reflectance maxima (extensive ripple) in the pass band. The auxiliary matching layers adjacent to the framing media (substrate and incident medium) are used to minimize this effect.

The efficiency of the protection technique described herein was investigated by coupling the emission of a Q-switched laser (A=1060 nm, repetition rate=110 Hz, pulse width=125 ns) into the fiber of the pump module. The test was performed for 5 s at each pulse power. Even after the irradiation with peak powers of 4.2 kW, the module showed no sign of damage or degradation.

Although the invention has been shown and described with respect to certain preferred embodiments, it is obvious that equivalents and modifications will occur to others skilled in the art upon the reading and understanding of the specification. For example, the filters 4 and 5 as described herein are not limited to the choice of coating materials identified. Other film forming materials may be used to achieve the desired effect without departing from the scope of the invention. For example, different materials, different numbers of materials, different numbers of layers, etc. may be used. Those having ordinary skill in the art will appreciate based on the disclosure herein the variety of types and designs of filters which may be utilized.

Further, while the invention is described herein in the context of pump light in the range of 900-1000 nm, it will be appreciated that the invention has applicability in other ranges of and is not limited to a specific wavelength range in the broadest sense. The properties of the laser sources and filters are adjusted accordingly.

The present invention includes all such equivalents and modifications, and is limited only by the scope of the following claims.

1. A multi-chip pump unit, including:
a light source; and
a filter for directing light from the light source towards an optical fiber,
wherein the filter exhibits one of either (i) relatively low transmissivity and high reflectivity at a wavelength of the light source, and relatively high transmissivity and low reflectivity at a wavelength greater than the wavelength of the light source; or (ii) relatively high transmissivity and low reflectivity at a wavelength of the light source, and relatively low transmissivity and high reflectivity at a wavelength greater than the wavelength of the light source.

2. The multi-chip pump unit of claim 1, wherein the filter exhibits relatively low transmissivity and high reflectivity at the wavelength of the light source, and relatively high transmissivity and low reflectivity at the wavelength greater than the wavelength of the light source.

3. The multi-chip pump unit of claim 1, wherein the filter exhibits relatively high transmissivity and low reflectivity at the wavelength of the light source, and relatively low transmissivity and high reflectivity at the wavelength greater than the wavelength of the light source.

4. The multi-chip pump unit according to claim 1, wherein the filter includes alternating layers of high index and low index material.

5. The multi-chip pump unit according to claim 4, wherein the high index layers include tantalum pentoxide.

6. The multi-chip pump unit according to claim 4, wherein the low index layers include silicon dioxide.

7. The multi-chip pump unit according to claim 4, wherein the thickness of a plurality of the alternating layers is a quarterwave of the wavelength of the light source.

8. The multi-chip pump unit according to claim 4, wherein the thickness of a plurality of the alternating layers adjacent an incident layer of the filter is non-quarterwave of the wavelength of the light source.

9. The multi-chip pump according to claim 4, wherein the filter is a cascaded Fabry-Perot type with high index spacers.

10. The multi-chip pump unit according to claim 1, wherein the wavelength of the light source is 750 nm to 1000 nm, more preferably 910 nm to 980 nm.

11. The multi-chip pump unit according to claim 1, wherein the wavelength greater than the wavelength of the light source is greater than 1000 nm.

12. The multi-chip pump unit according to claim 1, further including a second filter for directing the light from the light source towards the filter.

13. The multi-chip pump unit according to claim 12, wherein the second filter exhibits relatively low transmissivity and high reflectivity at a wavelength of the light source, and relatively high transmissivity and low reflectivity at a wavelength greater than the wavelength of the light source.

14. The multi-chip pump unit according to claim 1, wherein a direction of a light having the wavelength greater than the wavelength of the light source is opposite the direction of the light from the light source.

15. A method of pumping a fiber laser using a multi-chip pump module, including:
emitting a light from a light source; and
using a filter to direct the light from the light source towards an optical fiber, the filter exhibiting one of either (i) relatively low transmissivity and high reflectivity at a wavelength of the light source, and relatively high transmissivity and low reflectivity at a wavelength greater than the wavelength of the light source; or (ii) relatively high transmissivity and low reflectivity at a wavelength of the light source, and relatively low transmissivity and high reflectivity at a wavelength greater than the wavelength of the light source.

16. The method according to claim 15, wherein the filter exhibits relatively low transmissivity and high reflectivity at the wavelength of the light source, and relatively high transmissivity and low reflectivity at the wavelength greater than the wavelength of the light source.

17. The method according to claim 15, wherein the filter exhibits relatively high transmissivity and low reflectivity at the wavelength of the light source, and relatively low transmissivity and high reflectivity at the wavelength greater than the wavelength of the light source.

18. The method according to claim 15, further including using a second filter to direct the light from the light source towards the filter.

19. The method according to claim 15, wherein the wavelength of the light source is 750 nm to 1000 nm, more preferably 910 nm to 980 nm.

20. The method according to claim 15, wherein the wavelength greater than the wavelength of the light source is greater than 1000 nm.
